(19) United States
(12) Patent Application Publication
(10) Pub. No.: US 2005/0268020 A1
(43) Pub. Date: Dec. 1, 2005

(54) Data transfer system with bus

(76) Inventor: David B. James, Sacramento, CA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 10/856,897

(22) Filed: May 27, 2004

(51) Int. Cl. G06F 13/00

(52) U.S. Cl. 710/305

(57) ABSTRACT

A data transfer system has a bus having a plurality of bus lines, with the bus lines including at least a first and a second group of signal lines and at least a first and a second clock line. A host device is coupled to the plurality of bus lines. A first connector generates and outputs a first source synchronous signal on the first clock line and a first plurality of data signals on the first group and a second connector generates and outputs a second source synchronous signal on the second clock line and a second plurality of data signals on the second group. The host device is operable to respond to the first and second source synchronous signals and the first and second plurality of data signals to latch the first plurality of data signals with the first source synchronous signal and to latch the second plurality of data signals with the second source synchronous signal.

### BACKGROUND OF THE INVENTION

1. Field of the Invention

The present invention relates to data transfer systems, and in particular, to data transfer systems using digital buses.

2. Description of Related Art

Peripheral Component Interconnect (PCI) and Peripheral Component Interconnect-X (PCI-X) specifications have been developed and continued to be improved for communicating between a host device and various subsystem devices or adapters, such as devices interfacing to the PCI bus, plug-in adapter cards, or integrated adapters. The most current specification for PCI is in the PCI Local Bus Specification, Revision 1.0, published Sep. 26, 1999 by the PCI Special Interest Group (PCI 2.2). An Addendum for a PCI-X 1.0 specification and a PCI-X 2.0 specification has been included in the PCI 2.2 specification, pp. 1 through 262 (“PCI-X enhancements” collectively includes the PCI-X 1.0 and PCI-X 2.0 specifications).

The PCI-X enhancements generally are directed toward a point-to-point implementation to provide local I/O solutions for high-bandwidth applications, such as in the server and workstation segments of the computer industry. More specifically, the PCI-X 2.0 specification has four speed grades, which extend to the bus frequencies of 66 MHz (PCI-X 66), 133 MHz (PCI-X 133), 266 MHz (PCI-X 266) and 533 MHz (PCI-X 533). PCI-X 2.0 only supports point-to-point implementation at the highest speed grades of the specification (PCI-X 133, PCI-X 266, and PCI-X 533), i.e., only one PCI-X connector and one load may be supported by the host device. Point-to-point loads and multi-drop loads may be supported at the lower speeds of the PCI-X 2.0 standard. A PCI-X bus may support two connectors and two loads at 100 MHz (if PCI-X 133 adapter cards are used). Likewise, a PCI-X bus running at 66 MHz may support four connectors and four loads. The desire of having multidrop modes of PCI-X 133, PCI-X 266, and PCI-X 533 has been expressed by the PCI Special Interest Group (SIG), e.g., on one of its website pages, dated Nov. 5, 2002, but no enabling method or technique for doing so has been proposed.

The PCI 2.2 specification defines a number of mandatory bus or signal lines. For a given transaction, there is a PCI device that is an “initiator” (one initiating the transaction) and a target (selected PCI device on the other end of the transaction). These signal lines are divided into the following functional groups: (1) system lines including clock and strobe (source synchronous signals) and reset (RST#) lines; (2) address and data lines that are time multiplexed for addresses and data (64 AD lines) and other lines which are used to interpret and validate the signal lines that carry the addresses and data; (3) interface control lines for control the timing of transactions and provide coordination among initiators and targets, and error reporting lines used to report parity and other errors. Arbitration pins are also specified, but these are not relevant to PCI-X.

### BRIEF DESCRIPTION OF THE DRAWINGS

FIG. 1 is a block diagram of the bus data transfer system in accordance to one embodiment of the present invention.

FIG. 2 is a block diagram of the computer system including the bus data transfer system of FIG. 1.

### DETAILED DESCRIPTION OF ILLUSTRATIVE EMBODIMENTS

In the following description, for purposes of explanation, numerous details are set forth in order to provide a thorough understanding of the disclosed embodiments of the present invention. However, it will be apparent to one skilled in the art that these specific details are not required in order to practice the disclosed embodiments of the present invention. In other instances, well-known electrical structures and circuits are shown in block diagram form in order not to obscure the disclosed embodiments of the present invention.

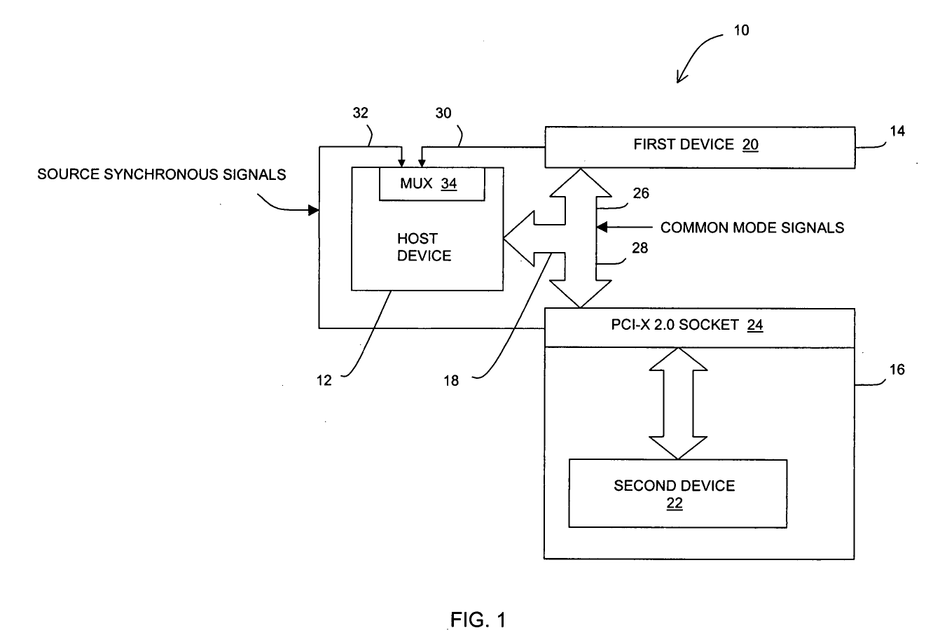

In FIG. 1 there is shown a data transfer system 10 according to one embodiment of the present invention. The data transfer system 10 includes a host device 12 and at least two PCI-X 2.0 compatible connectors, such as a first connector 14 and a second connector 16. The data transfer system 10 further includes a bus 18, with the host device 12 and the connectors 14 and 16 being coupled to the bus 18. The two connectors 14 and 16 define two connectors and two loads, contrary to the single load and connector contemplated by the PCI-X 2.0 specification for PCI-X 133, PCI-X 266, and PCI-X 533. Hence, the data transfer system 10 according to one embodiment of the present invention provides the capability to support more than one PCI-X compatible connector on the bus 18 with a single component, the host device 12. At speeds of 133 Mhz or greater, the ability to support multiple PCI-X compatible connectors, such as connectors 14 and 16, may allow for fewer components in the host device 12. Fewer components of the host device 12 may result in less cost, lower power requirements, and a smaller form factor.

The connectors 14 and 16 are subsystem components which may take a number of different forms, all of which incorporate the specification of and are compatible with PCI-X. As a first possibility, the connector 14 may comprise an embedded first device 20 which is directly coupled to the bus 18, with the embedded first device 20 being individually addressable by the PCI-X addressing protocol. In this example, the first device 20 may be directly soldered to the bus 18 without use of a PCI socket. As a second possibility, the connector 16 may comprise just a PCI socket for coupling a second device 22 to the bus 18, as illustrated by PCI socket 24 in FIG. 1. The second device 22 may be programmed with a unique socket address. The PCI socket 24, which may also be referred to as “PCI port”, defines a communications end point that has the unique socket address and is accessible through the PCI-X addressing protocol. The second device 22 is removably insertable into the PCI socket 24. In some cases, the second device 22 also may be commonly referred to as an “adapter card”, “add-in card” or “controller card”. Hence, the term “connector” is intended to encompass both devices and sockets, both of which are physically and electrically connected to the bus 18. The first device and the second device 22 may support PCI-X 66, PCI-X 133, PCI-X 266, and PCI-X 533. The connectors on the bus 18 may be all embedded devices or all PCI sockets or any mixture of both.

The bus 18 has a plurality of bus or signal lines which may be allocated to the first and second connectors 14 and 16 in a multidrop mode of operation. As one possibility, instead of the 64 bit, point-to-point mode of operation of the PCI-X 2.0 high speeds, each of the connectors 14 and 16 may utilize the same signal arrangement as the 32-bit multidrop mode operation of PCI-X 2.0, with the exception of the clock line and clock signal arrangement as will be described hereinafter. In this manner, the bus 18 is divided into two parallel groups of lines. More specifically, the lines of bus 18 may be divided into a first group 26 of signal lines and a second group 28 of signal lines dedicated to the first and second connectors 14 and 16, respectively. Physically, each of these signal lines are routed in a trace from the host device 12 to one of the connectors 14 or 16 and then to the other connector 16 or 14 in a daisy chain. Hence, operating in the multidrop mode, instead of the point-to-point mode contemplated by PCI-X, results in the signal lines in the first and second groups 26 and 28 being allocated or dedicated to the connector 14 and the connector 16, respectively. When operating in the point-to-point mode of PCI-X, instead of the multidrop mode of the data transfer system 10, all the signal lines of the first and second groups would be allocated to a single connector. In the data transfer system 10, more connectors may be added to the bus 18, in which case the signal lines of bus 18 may be further subdivided among the connectors.

The first and second groups 26 and 28 may include the address and data lines, interface control lines, and error reporting lines described in the Background section, with these lines being collectively referred to as “common mode signals”. Generally, each group 26 or 28 may have the same signal lines as provided for in the PCI-X 2.0 point-to-point specification for the high speeds of PCI-X 133, PCI-X 266, and PCI-X 533, except for the AD lines which are subdivided between the two groups 26 and 28. More specifically, the plurality of multiplexed address and data lines (AD lines) are allocated into two groups of AD lines, so as to define a first group of AD lines being dedicated to the first connector 14 and a second group of AD lines being dedicated to the second connector 16. For each additional socket or device added to the bus, a further subdivision of the use of the AD lines may be made.

The PCI-X specification at the higher speeds of PCI-X 266 and PCI-X 533 provides for a single clock line. However, in the data transfer system 10, according to one embodiment of the present invention, the clock lines from the connectors 14 and 16 are separately broken out as shown in FIG. 1. With two connectors 14 and 16, there are two clock lines. There is one dedicated clock line for each connector 14 and 16, which include a first clock line 30 and a second clock line 32, respectively. In other word, the clock lines 30 and 32 are separate traces from between the connector 14 and the host device 12 and between the connector 16 and the host device 12. In the event that additional connectors are added to the bus 18, additional clock lines may be added. These traces are dedicated to a given connector 14 or 16 and are not “in common” with the connectors 14 and 16.

As described above, each connector 14 and 16 transmits its own source synchronous signal to the host device 12 over its own clock lines 30 and 32, respectively. The host device 12 may be PCI-X 2.0 device, which supports PCI-X 66, PCI-X 133, PCI-X 266, and PCI-X 533, but which is modified to include a multiplexer 34 and to receive a plurality of source synchronous signals instead of a single source synchronous signal. The multiplexer 34 may be coupled to the clock lines 30 and 32 to multiplex, using, e.g., time division multiplexing (TDM), the first and second source synchronous signals, into a single multiplexed clock signal. In the case of additional connectors being added to the bus 18, the multiplexer 34 may be adapted to multiplex additional source synchronous signals. After multiplexing the signals on the lines 30 and 32, the host device 12 knows which TDM slots of the multiplexed clock signals correlate with the connectors 14 and 16 and may extract the first and second synchronous signal timing as needed for data latching purposes. The multiplexer 34 synchronizes the two independent source synchronous signals to the other signals from the connectors 14 and 16, i.e., the common bus signals, so that source synchronous signals may be used in the host device 12 to latch the data from the first and second connectors 14 and 16. Without the multiplexing of the signals on lines 30 and 32, it may be necessary to duplicate the pins and logic array of the host device 12 to accommodate two connectors instead of the one connector.

With respect to a data transaction where data is written from the host device 12 to one of the connectors 14 or 16, the source synchronous signal of the host device 12 is routed, along with the data from the host device 12, to the targeted connectors 14 or 16 over the lines 30 or 32. Hence, a single clock signal is generated by the host device 12 and provided to both connectors 14 and 16.

As an illustrative example showing the use of transmitted source synchronous signals from the connectors 14 and 16, the first and second connectors 14 and 16 may be located on the bus 18, for example, 3 inches and 5 inches, respectively, away from the host device 12. This creates different propagation delays for transmitting data from the connectors 14 and 16 to the host device 12. In order for the transfer of data to be successful on the bus 18, the phase relationships (or skews) between the clocks in the connectors 14 and 16 and the device 12 need to be as close as possible to zero degrees (also referred to as being “in phase”). To overcome this problem, the concept of source synchronous clocking is used in the data transfer system 10. The data transfer system 10, by use source synchronous clocking, transmits the clock (source synchronous signal) along with data over the bus 18. The transmitted clock is used in the host device 12 to latch the data into a register. This technique of the clock or strobe signal being forwarded with the data is referred to as a source synchronous clocking or clock-forwarded transfer and the signals are referred to as source synchronous signals.

PCI-X specification for the high speeds of PCI-X 266 and PCI-X 533 uses source synchronous clocking to transmit a clock or strobe (source synchronous signal) along with data over the PCI bus. These clock or strobe signals are used to trigger the clock inputs of the data latches and ensure that data signals are latched at the precise time. Because strobes and other signals are subject to the same variations in process, temperature, and voltage, they drift in the same direction, and with the same magnitude. Therefore, data may be latched securely, even at the very high data rates of PCI-X 533.

The specific signal lines for each of the previously-discussed categories of the signal lines in the PCI-X 2.0 specification are now presented in more detail. The lines are defined based upon the signals they carry. All of these signals are included in the previously described “common mode signals”. The common mode signals do not include any of the source synchronous signals. The address and data lines, other than the AD lines already described in the Background Section, include C/BE# lines, which carry multiplexed bus command and byte enable signals. During the data phase, these lines indicate which of the four byte lanes carry meaningful data. Additionally, there is a PAR line which provides even parity across AD and C/BE lines one clock cycle later. The interface control lines include a FRAME# line which is driven by current initiator to indicate the start and duration of a transaction. It is asserted at the start and deasserted when the initiator is ready to begin the final data phase. An IRDY# (Initiator Ready) line is driven by the initiator of transaction. During a read, it indicates that the initiator is prepared to accept data; during a write, it indicates that valid data are present on AD lines. A TRDY# (Target Ready) line is driven by the target. During a read, it indicates that valid data are present on AD lines; during a write, it indicates that target is ready to accept data. A STOP# line indicates that current target wishes the initiator to stop the current transaction. An IDSEL (Initialization Device Select) line is used as a chip select during configuration read and write transactions. A DEVSEL# (Device Select) line is asserted by the target when it has recognized its address. It indicates to current initiator whether any device has been selected.

In the data transfer system 10, a first and second plurality of common mode signals may be transmitted to the host device 12 from the connectors 14 and 16. A third and fourth plurality of common mode signals may be transmitted from the host device 12 to the connectors 14 and 16, respectively. With additional connectors, the number of these pluralities of common mode signals may correspondingly increase.

In summary, the PCI-X specifications represent a bus design that was intended by the industry to be a point-to-point interface between two devices or a device and a socket. One feature of the data transfer system 10, according to one embodiment of the present invention, is to provide the host device 12 with at least two connectors 14 and 16 co-located on the bus 18. This may result in utilizing previously unused bandwidth and may reduce the number of components required to enable the host device 12. This may be accomplished in the data transfer system 10 by utilizing the common mode PCI-X 2.0 bus signals (such as AD, IDSEL, DEVSEL, etc) in parallel amongst the connectors 14 and 16 on the bus 18 and breaking out the source synchronous signals from the connectors 14 and 16 that interface to the host device 12. By breaking out the source synchronous signals, the host device 12 may decode and synchronize all connectors on the bus, such as the connectors 14 and 16.

Although the data transfer system 10 is applicable to any computer platform, one desirable fit the system 10 is for its connectors, such as connectors 14 and 16, to provide high-performance I/O interfaces in systems such as enterprise servers, professional workstations, high-end UNIX servers, mainframes, and networking and communication applications. These systems may make use of the high bandwidth offered by PCI-X 266 and PCI-X 533. In these computer platforms, the higher-performance I/O interfaces of the data transfer system 10 may provide support for emerging, ultrahigh-bandwidth technologies such as 10 Gigabit Ethernet, 10 Gigabit FibreChannel, 4X and 12X InfiniBand, and others.

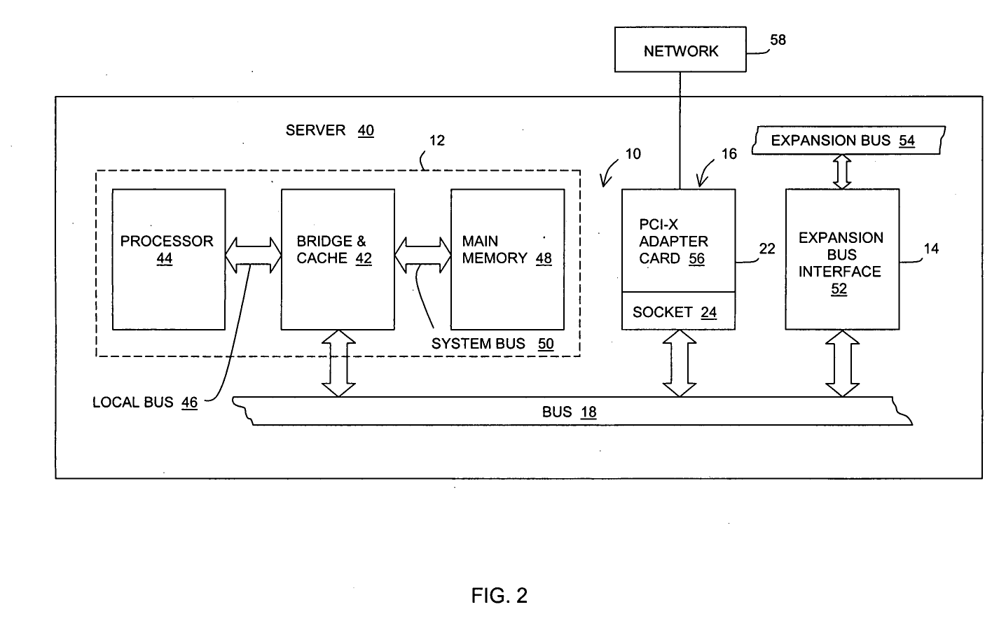

Referring to FIG. 2, there is illustrated one of many possible systems 40 in which the data transfer system 10 according to one embodiment of the present invention may be incorporated. The system 40 comprises a server with a high speed, multiple bus architecture. As in FIG. 1, the bus 18 is coupled to the host device 12, the first connector 14 and the second connector 16. The host device 12 may include a number of components, such as a bridge/cache 42 coupled to the bus 18, a processor 44 coupled to the bridge/cache by way of a local bus 46, and a main memory 48 coupled to the bridge/cache 42 by way of a system bus 50. The first connector 14 may have the first device in the form of an expansion bus interface 52, which provides a bridge and data buffer between the bus 18 and an expansion bus 54 having other input/output (I/O) components (not shown) coupled thereto. The second connector 16 may have the second device 22 in the form of a PCI-X adapter card 56, which may be a network interface card coupled to a high speed data network 58. Although the server 40 may have the above described four bus, high performance architecture, many other high-performance architectures are possible which may use the bus 18. Examples of the second device 22 include, but are not limited to, PCI-X adapter cards having a single port for 10 Gigabit Ethernet, 10 Gigabit FibreChannel, 4X InfiniBand or 12X InfiniBand or two ports for 10 Gigabit Ethernet or 10 Gigabit FibreChannel. Examples of the main memory 48 include, but are not limited to, static random access memory (SRAM) and dynamic random access memory (DRAM).

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. Therefore, it is manifestly intended that this invention be limited only by the claims and the equivalents thereof.

1. A data transfer system, comprising:
a bus having a plurality of bus lines, the bus lines including at least a first and a second group of signal lines and at least a first and a second clock line;
a host device coupled to the plurality of bus lines;
a first connector coupled to the first group of signal lines and the first clock line to generate and output a first source synchronous signal on the first clock line and a first plurality of data signals on the first group of signal lines;
a second connector coupled the second group of signal lines and the second clock line to generate and output a second source synchronous signal on the second clock line and a second plurality of data signals on the second group of signal lines; and
the host device coupled to the bus to respond to the presence of the first and second source synchronous signals and the first and second plurality of data signals to latch the first plurality of data signals with the first source synchronous signal and to latch the second plurality of data signals with the second source synchronous signal.

2. The data transfer system according to claim 1, wherein the host device is configured to generate and output a third source synchronous signal on both the first and second clock lines, a third plurality of data signals on the first group of signal lines, and a fourth plurality of data signals on the second group of signal lines; the first connector is configured to respond to the third plurality of data signals and the third source synchronous signal to latch the third plurality of data signals with the third source synchronous signal; and the second connector is configured to respond to the fourth plurality of data signals and the third source synchronous signal to latch the fourth plurality of data signals with the third source synchronous signal.

3. The data transfer system according to claim 1, wherein the host device includes a multiplexer, coupled to the first and second clock lines, to multiplex the first and second source synchronous signals to the host device.

4. The data transfer system according to claim 3, wherein the host device is configured to generate and output a third source synchronous signal on the first and second clock lines, a third plurality of data signals on the first group of signal lines, and a fourth plurality of data signals on the second group of signal lines; the first connector is configured to respond to the third plurality of data signals and the third source synchronous signal to latch the third plurality of data signals with the third source synchronous signal; and the second connector is configured to respond to the fourth plurality of data signals and the third source synchronous signal to latch the fourth plurality of data signals with the third source synchronous signal.

5. The data transfer system according to claim 4, wherein the first and second connectors are configured to be in compliance with at least a specification for Peripheral Component Interconnect (PCI)-X 533 compatible.

6. The data transfer system according to claim 4, wherein the first and second connectors are Peripheral Component Interconnect (PCI)-X 266 and PCI-X 533 compatible.

7. The data transfer system according to claim 1, wherein each of the first and second plurality of data signals includes multiplexed address and data signals.

8. The data transfer system according to claim 7, wherein the first connectors generates and outputs on the first group of signal lines a first plurality of common mode signals including the first plurality of multiplexed address and data signals and the second connector generates and outputs on the second group of signal lines a second plurality of common mode signals including the second plurality of multiplexed address and data signals.

9. The data transfer system according to claim 8, wherein each of the source synchronous signals comprises a clock signal forwarded from the respective connector or host device.

10. The data transfer system according to claim 9, wherein one of the connectors is a PCI-X compatible socket; and the data transfer system further comprises a device, coupled to the PCI-X compatible socket, with the device supporting at least PCI-X 266 and PCI-X 533; and the host device includes a processor and a memory coupled to the processor.

11. The data transfer system according to claim 9, wherein one of the connectors is a device directly coupled to the bus, with the device supporting at least PCI-X 266 and PCI-X 533; and the host device includes a processor and a memory coupled to the processor.

12. A data transfer system, comprising:
a bus having a plurality of bus lines, the bus lines including at least a first and a second group of signal lines and at least a first and a second clock line;
a host device coupled to the plurality of bus lines;
at least a first and a second connector coupled to the first and second groups, the first connector being coupled to the first clock line, and the second connector being coupled to the second clock line;
the first group of lines being operable to carry a first plurality of address and data signals to or from the first connector and the second group of lines being operable to carry a second plurality of address and data signals to or from the second connector; and
the first connector being operable to generate a first source synchronous signal on the first clock line, the second connector being operable to generate a second source synchronous signal on second clock line, and the host device being operable to generate a third source synchronous signal on the first and second clock lines.

13. The data transfer system according to claim 12, wherein the first connector is operable to generate the first plurality of address and data signals; the second connector is operable to generate the second plurality of address and data signals; the host device includes a multiplexer, coupled to the first and second clock lines, to multiplex the first and second source synchronous signals; the host device, in response to the first and second source synchronous signals and the first and second plurality of address and data signals, being operable to latch the first plurality of data signals from the first connector and to latch the second plurality of data signals from the second connector.

14. The data transfer system according to claim 12, wherein the host device is operable to generate the first plurality of address and data signals on the first group, and the second plurality of address and data signals on the second group; the first connector, in response to the first plurality of data signals and the third source synchronous signal, being operable to latch the first plurality of data signals with the third source synchronous signal; and the second connector, in response to the second plurality of data signals and the third source synchronous signal, being operable to latch the second plurality of data signals with the third source synchronous signal.

15. The data transfer system according to claim 12, wherein the first and second connectors support at least Peripheral Component Interconnect (PCI)-X 266 and PCI-X 533.

16. The data transfer system according to claim 15, wherein the first connector generates on the first group a first plurality of common mode signals including the first plurality of address and data signals and the second connector generates on the second group a second plurality of common mode signals including the second plurality of address and data signals.

17. A method for providing data transfers between a host device and at least a first and a second connector, comprising:
interconnecting the host device and the first and second connectors with a bus;
generating at the first connector a first source synchronous signal and a first data signal and transmitting the first source synchronous signal and the first data signal over a first portion of the bus to the host device;
generating at the second connector a second source synchronous signal and a second data signal and transmitting the second source synchronous signal and the second data signal over a second portion of the bus to the host device, the first source synchronous signal being independent of the second source synchronous signal and the first and second portions of the bus being different portions;
latching the first data signal with the first source synchronous signal at the host device; and
latching the second data signal with the second source synchronous signal at the host device.

18. The method according to claim 17, further comprising:
generating at the host device a third source synchronous signal and a third data signal and transmitting the third source synchronous signal and the third data signal over the first portion of the bus to the first connector;
generating at the host device a fourth data signal and transmitting the third source synchronous signal and the fourth data signal over the second portion of bus to the second connector;
latching the third data signal with the third source synchronous signal at the first connector; and
latching the fourth data signal with the third source synchronous signal at the second connector.

19. The method according to claim 18, wherein latching the first data signal and latching the second data signal includes multiplexing the first and second source synchronous signals to generate a multiplexed clock signal prior to latching the first and second data signals.

20. The method according to claim 17, wherein the first and second connectors are compatible with at least a specification for Peripheral Component Interconnect (PCI)-X 266 or PCI-X 533.

21. The method according to claim 17, wherein generating the first data signal further includes generating a first plurality of common mode signals including the first data signal and generating the second data signal further includes generating a second plurality of common mode signals including the second data signal.

22. A system for a computer platform, comprising a bus having a plurality of bus lines, the bus lines including at least a first and a second group of signal lines and at least a first and a second clock line; a host device coupled to the plurality of bus lines; a first connector, coupled to the first clock line and the first group of signal lines, to generate and output a first source synchronous signal on the first clock line and a first plurality of data signals on the first group of signal lines and a second connector, coupled to the second clock line and the second group of signal lines, to generate and output a second source synchronous signal on the second clock line and a second plurality of data signals on the second group of signal lines; the host device, in response to the first and second source synchronous signals and the first and second plurality of data signals, being operable to latch the first plurality of data signals with the first source synchronous signal and to latch the second plurality of data signals with the second source synchronous signal; and at least one of the connectors comprising a socket and a network adapter card coupled to the socket, the socket and the network adapter card being compatible with at least a specification for Peripheral Component Interconnect (PCI)-X 266 or PCI-X 533.

23. The system according to claim 22, wherein the network adapter card comprises one of a 10 Gigabit Ethernet adapter card or a 10 Gigabit FibreChannel adapter card.

24. The system according to claim 22, wherein the computer platform is a server and the host device includes a processor and a memory coupled to the processor.

25. The system according to claim 22, wherein the host device is configured to generate and output a third source synchronous signal on both the first and second clock lines, a third plurality of data signals on the first group, and a fourth plurality of data signals on the second group; the first connector, in response to the third plurality of data signals and the third source synchronous signal, being configured to latch the third plurality of data signals with the third source synchronous signal; and the second connector, in response to the fourth plurality of data signals and the third source synchronous signal, being configured to latch the fourth plurality of data signals with the third source synchronous signal.

26. The system according to claim 22, wherein the host device includes a multiplexer, coupled to the first and second clock lines, to multiplex the first and second source synchronous signals; the host device, in response to the fist and second source synchronous signals, being operable to latch the first plurality of data signals and to latch the second plurality of data signals.

27. The system according to claim 26, wherein the host device is configured to generate and output a third source synchronous signal on the first and second clock lines, a third plurality of data signals on the first group, and a fourth plurality of data signals on the second group; the first connector, in response to the third plurality of data signals and the third source synchronous signal, being configured to latch the third plurality of data signals with the third source synchronous signal; and the second connector, in response to the fourth plurality of data signals and the third source synchronous signal, being configured to latch the fourth plurality of data signals with the third source synchronous signal.

28. The system according to claim 27, wherein the first and second connectors are configured to be compatible with the specifications for PCI-X 266 and PCI-X 533.

29. The system according to claim 28, wherein each of the plurality of data signals includes multiplexed address and data signals.
